(19) United States
(12) Patent Application Publication
(10) Pub. No.: US 2026/0219399 A1
(43) Pub. Date: Jul. 30, 2026

(54) MONITORING MULTIPLE SIGNALS SIMULTANEOUSLY USING UNDERSAMPLING

(71) Applicant: Swift Beat, LLC, Menlo Park, CA (US)

(72) Inventor: Joseph A. KAISER, JR., Hopkinton, MA (US)

(21) Appl. No.: 19/458,442

(22) Filed: Jan. 23, 2026

Related U.S. Application Data
(60) Provisional application No. 63/749,462, filed on Jan. 24, 2025.

(51) Int. Cl. G01S 19/42; G01S 19/21

(52) U.S. Cl. CPC G01S 19/426; G01S 19/21

(57) ABSTRACT

A system includes a processor and a memory configured to cause the processor to receive a first navigation system signal associated with a first frequency, receive a second navigation system signal associated with a second frequency, sample the first navigation system signal using a first undersampling rate such that a frequency of the sampled first navigation system signal falls in a first Nyquist zone of an ADC, sample the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously, monitor the sampled first navigation system signal and the sampled second navigation system signal simultaneously using the ADC, and cause a response action to be performed in response to the monitoring.

### CROSS-REFERENCE TO RELATED APPLICATIONS

This non-provisional utility application claims priority to provisional patent application number 63/749,462, entitled “MONITORING MULTIPLE SIGNALS SIMULTANEOUSLY USING UNDERSAMPLING” and filed on Jan. 24, 2025, which is incorporated herein in its entirety by reference.

### BACKGROUND

Navigation systems require the use of various signals, such as from Global Navigation Satellite Systems (GNSSs) including global positioning system (GPS), Galileo, GLONASS, BeiDou, IRNSS/NAVIC, and QZSS.

### SUMMARY

In one aspect, a system includes a processor, and a memory including computer program code. The memory and the computer program code are configured to cause the processor to receive a first navigation system signal associated with a first frequency, receive a second navigation system signal associated with a second frequency, sample the first navigation system signal using a first undersampling rate such that a frequency of the sampled first navigation system signal falls in a first Nyquist zone of an analog to digital converter (ADC), sample the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously, monitor the sampled first navigation system signal and the sampled second navigation system signal simultaneously using the ADC, and cause a response action associated with at least one of the first navigation system signal or the second navigation system signal to be performed in response to the monitoring.

In another aspect, a computerized method includes selecting a sampling frequency within capabilities of an analog to digital converter (ADC), determining carrier frequencies of a group of global navigation satellite system (GNSS) signals, calculating folding factors of the group of GNSS signals using the determined carrier frequencies and the selected sampling frequency, wherein the calculated folding factors cause associated aliases of the group of GNSS signals to fall within a first Nyquist zone of the ADC, determining that the associated aliases of the group of GNSS signals occupy separate ranges of the first Nyquist zone of the ADC, monitoring the group of GNSS signals simultaneously using the selected sampling frequency, detecting interference associated with at least one signal of the group of signals based on the monitoring, and causing a GNSS interference response action to be performed based on detecting interference.

In another aspect, a computerized method includes receiving a first navigation system signal associated with a first frequency, receiving a second navigation system signal associated with a second frequency, sampling the first navigation system signal using a first undersampling rate such that a frequency of the sampled first navigation system signal falls in a first Nyquist zone of an analog to digital converter (ADC), sampling the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously, monitoring the sampled first navigation system signal and the sampled second navigation system signal simultaneously using the ADC, detecting interference based on the monitoring, and causing a response action associated with at least one of the first navigation system signal or the second navigation system signal to be performed in response to the detected interference.

### BRIEF DESCRIPTION OF THE DRAWINGS

FIG. 1 is a schematic diagram illustrating a system for monitoring received GNSS signals according to an implementation.

FIG. 2 is a flowchart illustrating a method of operation of the system of FIG. 1 according to an implementation.

FIG. 3 is a flowchart illustrating a method of operation of the system of FIG. 1 according to an implementation.

FIG. 4 is a schematic diagram illustrating an analog-to-digital converter (ADC) of the system of FIG. 1 according to an implementation.

FIG. 5 is a schematic diagram illustrating the system of FIG. 1 being deployed onboard a mobile platform according to an implementation.

FIG. 6 is a flowchart illustrating a method of operation of the system of FIG. 1 according to an implementation.

FIG. 7 is a flowchart illustrating a method of operation of the system of FIG. 1 according to an implementation.

FIG. 8 is a schematic diagram illustrating an exemplary operating environment of the disclosure according to an implementation.

### DETAILED DESCRIPTION

Traditional navigation systems often utilize analog-to-digital converters (ADCs) with relatively narrow bandwidth capacities, for example not exceeding a few hundred megahertz. These systems usually operate with higher sample rates to ensure fidelity in capturing high-frequency signals, often resulting in increased power consumption and processing complexity. Further, existing systems do not effectively address the challenge of simultaneous reception across multiple frequency bands, particularly in high-interference environments. Overall, existing Global Navigation Satellite Systems (GNSSs) signal processing presents limitations in terms of bandwidth efficiency, adaptive capabilities, historical interference analysis, and advanced algorithmic refinements.

In contrast, the systems and methods disclosed herein provide enhanced signal processing for signals such as, but not limited to, GNSS and/or the like. While some examples are described with reference to GNSS, or global positioning system (GPS) more specifically, aspects of the disclosure are operable with any signal from any navigation system. In some examples, the system's capabilities are applied to other domains involving radio frequency (RF) signal processing. This includes, but is not limited to, wireless communication systems, radar systems, other high-frequency signal monitoring applications, and/or the like.

Aspects of the disclosure can be applied in a variety of scenarios such as, but not limited to: integrating the system into aerial and non-aerial platforms to ensure reliable navigation and positioning even in environments with potential GNSS signal interference; using the technology in ships and marine vessels which can benefit from the system's capability to handle multiple GNSS signals to ensure precise navigation in the open sea and/or near ports where interference may be encountered; enabling emergency response teams for reliable navigation and coordination during critical operations in urban and remote areas; using the technology in advanced driver-assistance systems (ADAS) and autonomous vehicles to enable robust signal processing ensuring accurate navigation and positioning to contribute to safety and performance in diverse driving conditions; and using the system to support precision agriculture technologies by delivering accurate positioning data for automated watering and/or harvesting equipment and monitoring systems.

Aspects of the disclosure provide systems and methods for simultaneously monitoring multiple GNSS signals, analyzing the monitored signals for interference and/or other notable patterns, and causing actions to be performed in response to the detected behaviors. Multiple GNSS signals associated with multiple different frequencies are received. The GNSS signals are sampled using undersampling rates such that the sampled GNSS signals fall in a first Nyquist zone of an analog to digital converter (ADC). The ADC is used to simultaneously monitor the sampled GNSS signals and, during the monitoring, GNSS interference is detected. In response to the detected GNSS interference, a GNSS response action is caused to be performed.

The disclosure operates in an unconventional manner at least by providing the technical solution of undersampling the multiple GNSS signals such that the frequencies of the sampled GNSS signals (e.g., aliases of the GNSS signals) fall in the first Nyquist zone of an ADC. By undersampling the signals in this manner, aspects of the disclosure provide the technical effect of enabling the ADC and associated modules and/or devices to monitor activity on those GNSS signals simultaneously without significant interference. Thus, these aspects of the disclosure perform monitoring that would otherwise require more devices, more complicated devices, and/or more processing. The disclosure provides the technical effect of improved functionality of devices implementing ADCs at least with respect to receiving and monitoring multiple GNSS signals. These improvements include improved efficiencies with respect to system resource usage, such as memory usage, processing resource usage, and the like.

By monitoring multiple GNSS bands in a single capture, in some examples, the system is equipped to execute several advanced functionalities. For example, with simultaneous access to signals from the L1, L2, and L5 GPS bands (or other groups of GNSS signals), the system achieves improved positioning accuracy by employing multi-frequency measurements to correct ionospheric errors and reduce multipath effects. The technical solution of this multi-band approach supports the technical effect of more reliable and precise location determination. Further, in some examples, the technical solution of monitoring multiple bands allows for the technical effect of increased sensitivity in detecting signal anomalies and interference patterns, including intentional and/or inadvertent interference. The ability to cross-reference signals across different bands enhances the identification and differentiation processes, leading to more effective interference classification and mitigation strategies.

Additionally, or alternatively, in some examples, by providing the technical solution of analyzing the phase and group delay differences among the multiple bands, the system provides the technical effect of improving the corrections applied for ionospheric and tropospheric delays. This results in higher precision in timing and ranging applications, crucial for applications requiring exact synchronization. The technical solution of concurrent capture of signals across multiple bands enables the system to perform a comprehensive quality assessment of the received signals, providing the technical effect of identifying discrepancies and validating signal integrity. This facilitates improved decision-making in real-time processing and enhances the reliability of navigation solutions.

Further, in some examples, by performing the technical solution of comparing the phase, frequency, and timing information across the multiple bands, the system can detect and mitigate against GNSS spoofing attempts, which may not manipulate all frequency bands uniformly. This provides the technical effect of an additional layer of security in secure navigation applications. The technical solution of continuous monitoring of multiple GNSS bands provides the technical effect of enhancing the tracking capabilities of the system, enabling more rapid acquisition and re-acquisition of satellite signals, especially in challenging environments such as urban canyons or densely wooded areas, ensuring sustained navigational accuracy.

Additionally, in some examples, the system, using inputs from multiple signal bands, provide the technical solution of dynamically adapting to changing environmental conditions, providing the technical effect of improving the system's ability to maintain signal integrity and reliability in diverse and/or fluctuating signal environments. This adaptability is especially beneficial in mobile platforms such as aviation and maritime applications, where environmental variables significantly impact signal clarity.

The described systems and methods for enhanced signal processing and interference detection differ from the prior art in several notable ways. For example, the invention employs an ADC capable of processing wideband signals up to 6 GHz with a sample rate of up to 600 mega samples per second. The system utilizes advanced undersampling techniques to down-convert multiple GNSS frequency bands into the first Nyquist zone of the ADC, allowing for simultaneous monitoring and processing across GNSS constellations. Unlike existing methods, which may not effectively address simultaneous multi-band reception, this invention improves processing efficiency and reduces complexity thereby improving the functioning of the underlying device. The system distinguishes and processes multiple types of GPS interference using both narrowband and wideband modes.

The processing described herein is augmented by tracking and classifying interference sources, as well as creating a historical ‘heat map’ for direction-of-arrival calculations. Such capabilities surpass the static assumptions and limited adaptability seen in conventional interference detection approaches. Aspects of the disclosure provide fully programmable digital receivers, enabling dynamic adjustment of capture bandwidth, sampling rate, filtering, and decimation based on threat levels and operational needs. The system allows for both offline and/or real-time calibration, using multiple transmit antennas to accommodate changes due to environmental factors, ADC restarts, and/or the like. This capability supports continuous signal integrity and phasing, unlike the prior art where calibration is often conducted offline with limited real-time adaptability.

In some aspects, the simultaneous nature of using an undersampling scheme as described herein to capture signals includes capturing power levels and phase deltas between the signals as received at various antennas in a direction finding system.

Aspects of the disclosure operation in an unconventional manner at least by providing a method that includes receiving a first navigation system signal associated with a first frequency, receiving a second navigation system signal associated with a second frequency, sampling the first navigation system signal using a first undersampling rate such that a frequency of the sampled first navigation system signal falls in a first Nyquist zone of an ADC, sampling the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously, monitoring the sampled first navigation system signal and the sampled second navigation system signal simultaneously using the ADC, and causing a response action associated with at least one of the first navigation system signal or the second navigation system signal to be performed in response to the monitoring.

Aspects of the disclosure operation in an unconventional manner at least by providing a method that includes selecting a sampling frequency within capabilities of an ADC, determining carrier frequencies of a group of GNSS signals, calculating folding factors of the group of GNSS signals using the determined carrier frequencies and the selected sampling frequency, wherein the calculated folding factors cause associated aliases of the group of GNSS signals to fall within a first Nyquist zone of the ADC, determining that the associated aliases of the group of GNSS signals occupy separate ranges of the first Nyquist zone of the ADC, monitoring the group of GNSS signals simultaneously using the selected sampling frequency, detecting interference associated with at least one signal of the group of signals based on the monitoring, and causing a GNSS interference response action to be performed based on detecting interference.

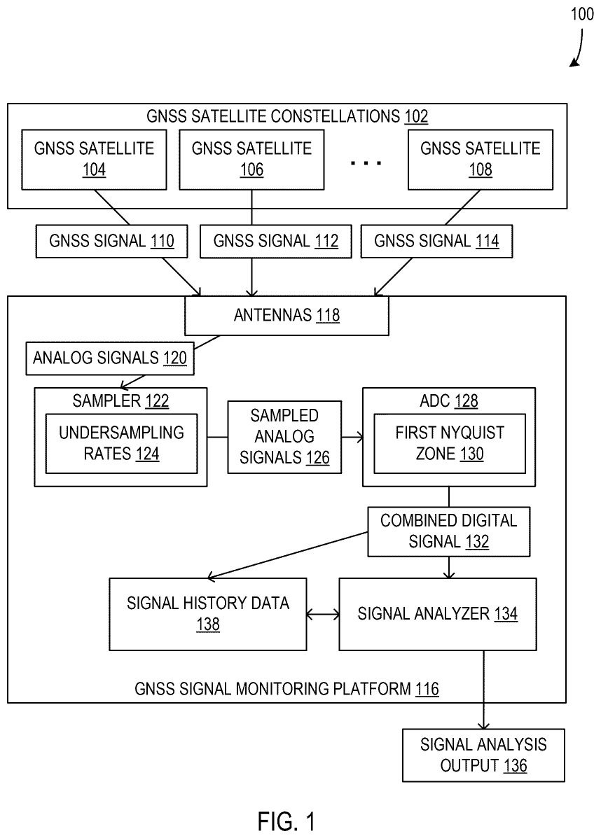

Referring next to the figures, FIG. 1 is a block diagram illustrating an example system 100 configured for receiving GNSS signals 110-114 and monitoring the received GNSS signals 110-114 simultaneously using undersampling (e.g., by the sampler 122) and an associated ADC 128.

In some examples, one or more GNSS satellite constellations 102 include a plurality of GNSS satellites (e.g., GNSS satellites 104, 106, and 108) which are configured to orbit Earth or another planet, moon, and/or similar object and enable devices to determine position and navigate thereby. The GNSS satellites 104-108 emit GNSS signals (e.g., GNSS signals 110, 112, and 114) that are then received devices on or near the Earth and/or other object around which the GNSS satellites orbit, such as, but not limited to, the GNSS signal monitoring platform 116 and/or the like.

The GNSS signal monitoring platform 116 includes hardware, firmware, and/or software configured to capture or otherwise receive GNSS signals 110-114, sample the analog signals 120 using undersampling rates 124, and convert the sampled analog signals 126 to a combined digital signal 132 using the ADC 128. Then, the combined digital signal 132 is analyzed using a signal analyzer 134 which generates signal analysis output 136 (e.g., indicators of GNSS signals being jammed or otherwise interfered with). Additionally, or alternatively, the combined digital signal 132 and/or any associated signal analysis output 136 are stored as signal history data 138 for future use by the GNSS signal monitoring platform 116 and/or other device and/or user.

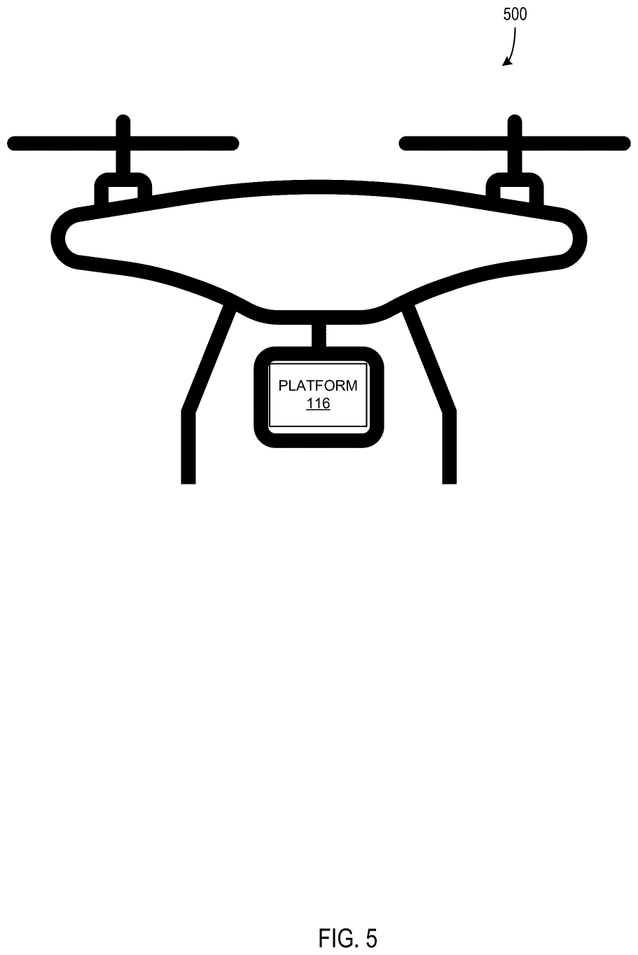

In some examples, the GNSS signal monitoring platform 116 includes, is part of, is used with, is implemented in, and/or is associated with a platform, such as, but not limited to, a mobile platform (e.g., the mobile platform 500 shown in FIG. 5, etc.), a stationary platform, and/or the like. For example, the GNSS signal monitoring platform 116, in some examples, is configured for use onboard a platform. In some examples, the GNSS signal monitoring platform 116 is used with (e.g., onboard, onboard control, remote from, remote control, etc.) one or more uncrewed, autonomous platforms.

Examples of mobile platforms include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), marine vehicles (e.g., boats, ships, etc.), surface vehicles, submersibles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), animals (e.g., a flying animal such as a bird and/or insect, a land animal, a marine animal, etc.), missiles, rockets, uncrewed mobile platforms, autonomous mobile platforms, and/or the like. As used herein, the GNSS signal monitoring platform 116 may be used onboard a mobile platform while the mobile platform is moving and/or while the mobile platform is stationary.

Examples of stationary platforms include, but are not limited to, stations, arrays, central controls, centralized control stations, towers, cellular towers, fixed positions, fixed structures, stationary vehicles, uncrewed stationary platforms, autonomous stationary platforms, buildings, emplacements, installations, ground-based installations, forts, prisons, government locations, government buildings, stadiums, parks, public spaces, infrastructure, dams, public venues, private venues, concert venues, sporting venues, and/or the like.

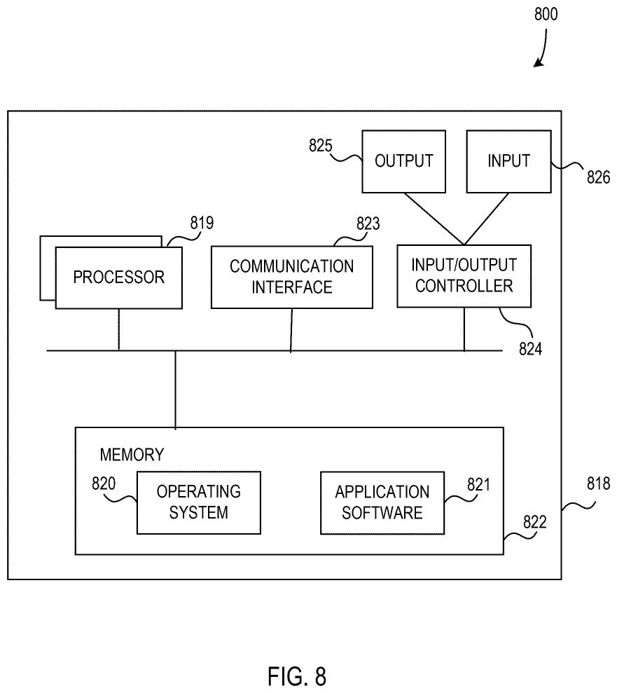

Further, in some examples, the system 100 includes one or more computing devices (e.g., the computing apparatus of FIG. 8) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, components of the GNSS signal monitoring platform 116 (e.g., the sampler 122, the ADC 128, and/or the signal analyzer 134) are executed on separate computing devices and those separate computing devices are configured to communicate with each other via network connections during the operation of the GNSS signal monitoring platform 116. In other examples, other organizations of computing devices are used to implement system 100 without departing from the description.

The GNSS signal monitoring platform 116 includes or is otherwise connected to one or more antennas 118 that are configured to receive the GNSS signals 110-114. It should be understood that, in some examples, the antennas 118 include antennas configured to receive GNSS signals 110-114 from any or all of the GNSS satellite constellations 102 (e.g., GPS, Galileo, GLONASS, BeiDou, IRNSS/NAVIC, and QZSS). In some examples, the system 100 is configured to operate with any array of antennas. Such configurations include a multi-antenna setup (e.g., four antennas) capable of capturing signals from multiple GNSS constellations. However, in some such examples, optimal performance parameters, such as the number and strategic positioning of antennas, may influence the effectiveness of the system 100 in specific applications.

The analog signals 120 received by the antennas 118 are provided to the sampler 122. In some examples, the sampler 122 includes hardware, firmware, and/or software configured to determine undersampling rates 124 that enable the received analog signals 120 to be under sampled such that the resulting sampled analog signals 126 fall in the first Nyquist zone 130 of the ADC 128. Upon determining the undersampling rates 124, the sampler 122 samples each analog signal 120 at the determined undersampling rates 124 to form the sampled analog signals 126, which are then provided to the ADC 128.

Further, in some examples, the ADC 128 includes hardware, firmware, and/or software configured to convert the sampled analog signals 126 to a combined digital signal 132, such that the multiple GNSS signals 110-114 can be monitored simultaneously using the combined digital signal 132. Because the signals have been undersampled to fall into the first Nyquist zone 130, the ADC 128 and associated components of the GNSS signal monitoring platform 116 are enabled to efficiently monitor those signals while avoiding interference from aliasing or other sources. This reduces the need for multiple devices to monitor the multiple GNSS signals and/or using techniques to switch between the multiple GNSS signals, resulting in loss of information therefrom.

In some examples, the signal analyzer 134 includes hardware, firmware, and/or software configured to analyze the combined digital signal 132 and to generate signal analysis output 136 based thereon. In some such examples, the signal analyzer 134 analyzes the strength of the GNSS signals within the combined digital signal 132, patterns in the GNSS signals, changes to the GNSS signals, or the like. Additionally, or alternatively, data from the combined digital signal 132 is compared to or otherwise analyzed with respect to data from the signal history data 138, enabling the detection of common patterns or changes, identification of events similar to those that occurred in the past, or the like.

Further, aspects of the disclosure employ an ADC 128 capable of processing wideband signals up to 6 GHz with a sample rate of up to 600 mega samples per second. In some examples, the ADC 128 utilizes (e.g., relatively advanced) undersampling techniques to down-convert multiple GNSS frequency bands of the GNSS signals 110-114 into the first Nyquist zone, facilitating simultaneous monitoring and processing across various GNSS constellations, improving efficiency, and reducing complexity compared to traditional systems. In some examples, the described systems and/or methods leverage undersampling (e.g., using the sampler 122 and the associated undersampling rates 124) to simultaneously receive and/or observe multiple GNSS signals, for example as described herein.

In some examples, the system 100 is integrated into a UAV platform to provide more reliable navigation and/or positioning, for example even in environments with potential GPS jamming, interference, and/or the like. The signal processing and jammer detection features disclosed herein enable operations in areas where GPS signals may be deliberately disrupted.

Additionally, or alternatively, the system 100 encompasses enhanced GPS jammer detection with the ability to distinguish multiple jammers using both narrowband and wideband modes. In some examples, the system 100 tracks and classifies interference sources, employing a historical ‘heat map’ for direction-of-arrival calculations. Optionally, the system 100 features fully programmable digital receivers, for example enabling dynamic adjustment of capture bandwidth, sampling rate, filtering, and/or decimation based on varying threat levels and/or operational requirements, offering improvements over traditional systems with more constrained flexibility, and/or the like.

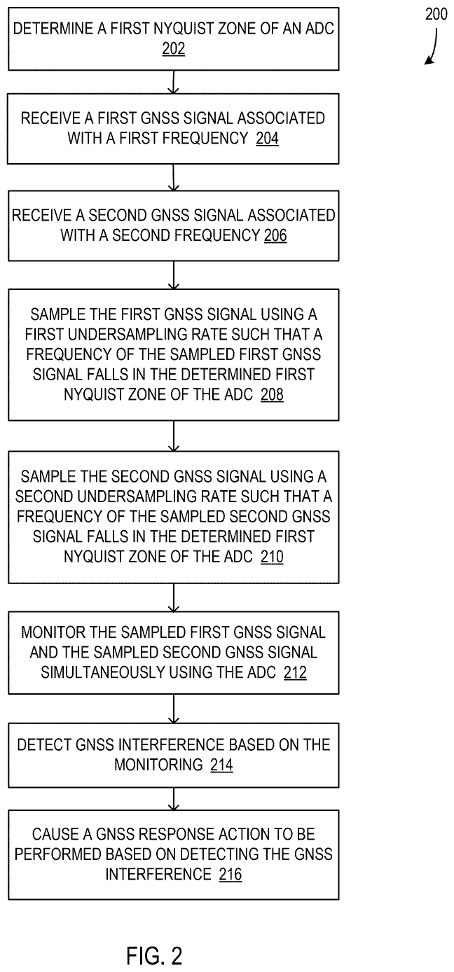

FIG. 2 is a flowchart illustrating an example method 200 for monitoring a first GNSS signal and a second GNSS signal simultaneously to detect GNSS interference. In some examples, the method 200 is executed or otherwise performed in or in association with a system such as, but not limited to, the system 100 of FIG. 1.

At 202, the first Nyquist zone (e.g., first Nyquist zone 130) of an ADC (e.g., ADC 128) is determined. In some examples, the first Nyquist zone is determined based on a sampling rate that is within the capabilities of the ADC.

At 204, a first GNSS signal associated with a first frequency is received and, at 206, a second GNSS signal associated with a second frequency is received. In some examples, the GNSS signals are received via one or more antennas of a device or system such as, but not limited to, the GNSS signal monitoring platform 116.

At 208, the first GNSS signal is sampled using a first undersampling rate such that the frequency of the sampled first GNSS signal falls in the determined first Nyquist zone of the ADC. At 210, the second GNSS signal is sampled using a second undersampling rate such that a frequency of the sampled second GNSS signal falls in the determined first Nyquist zone of the ADC. In some examples, the first undersampling rate and the second undersampling rates are chosen such that the frequencies of the aliases of the sampled first GNSS signal and the sampled second GNSS signal do not overlap or otherwise interfere with each other.

At 212, the sampled first GNSS signal and the sampled second GNSS signal are monitored simultaneously using the ADC. This simultaneous monitoring is enabled by the sampled signals being within the first Nyquist zone of the ADC.

At 214, GNSS interference is detected based on the monitoring. At 216, a GNSS response action is caused to be performed based on detecting the GNSS interference. In some examples, data associated with the GNSS interference is recorded and/or analyzed to determine a type of GNSS response action to be performed. In some examples, GNSS response actions include causing a device to change to using a different GNSS channel or constellation, causing a vehicle or group of vehicles to change a route of the vehicle(s) (e.g., be routed away from the detected GNSS interference), causing a heat map (e.g., indicative of the GNSS interference) to be displayed and/or otherwise provided, and/or the like.

In some examples, the method 200 includes determining the appropriate undersampling rate for each respective GNSS frequency band, such that the aliased frequencies of interest correctly map into the first Nyquist zone of the ADC without overlapping or otherwise interfering with each other. This selection facilitates the simultaneous reception and processing of signals across diverse GNSS constellations (e.g., GPS, Galileo, GLONASS, BeiDou, IRNSS/NAVIC, and QZSS), while effectively avoiding inter-band interference.

By concentrating the frequency components into the first Nyquist zone, the method 200 simplifies the subsequent digital signal processing tasks, reducing the complexity inherent in having separate processing paths for each GNSS signal band. This approach allows for a more unified and more efficient processing schema, enhancing overall signal acquisition and processing capabilities, for example in environments with (e.g., substantial) interference challenges.

In some examples, the undersampling technique employed in the method 200 leverages specific mathematical operations to achieve the down-conversion of multiple GNSS frequency bands into the first Nyquist zone of the ADC. For example, the undersampling technique may be characterized by the mathematical considerations of sampling frequency and aliasing, frequency folding, band separation and interference avoidance, and/or the like.

For example, with respect to sampling frequency and aliasing, given a bandpass signal with carrier frequency f_{c} and bandwidth B, the selected sampling frequency fₛ must satisfy |f_{c}−nfₛ|<fₛ/2 for an integer n, where n represents the folding factor corresponding to how many times the signal “folds” to fit the first zone. This ensures that the aliased version of the signal fits within the first Nyquist zone of the ADC, which ranges from 0 to fₛ/2. The specific selection of fₛ effectively determines n and, thereby, the ultimate position of the aliased signal. It should be understood that, when |f_{c}−nfₛ|<fₛ/2 as stated above is true and nfₛ>f_{c} (for the given ‘n’ chosen) the spectrum of the signal contained within bandwidth B will be inverted (meaning that the bandwidth signals on either side of f_{c} are swapped), which will have negative consequences if the modulation within B requires demodulation. In this case, further signal processing is needed to reverse the signal spectrum. Any number of a variety of DSP techniques may be employed.

With respect to frequency folding, the principle of frequency folding relies on undersampling the input GNSS signals at a rate that exploits their periodic nature. This periodic nature is mathematically expressed as (f_{c}−nfₛ) \mod fₛ, which simplifies the subsequent digital processing by effectively down-converting the higher frequency components into a lower frequency range that the ADC can handle.

With respect to band separation and interference avoidance, by ensuring that the selected fₛ achieves the correct aliasing, the method inherently prevents overlap of aliased signals from different GNSS bands, thus avoiding inter-band interference. The system calculates this by solving for n such that each target frequency component lies within separate, non-overlapping bands in the first Nyquist zone.

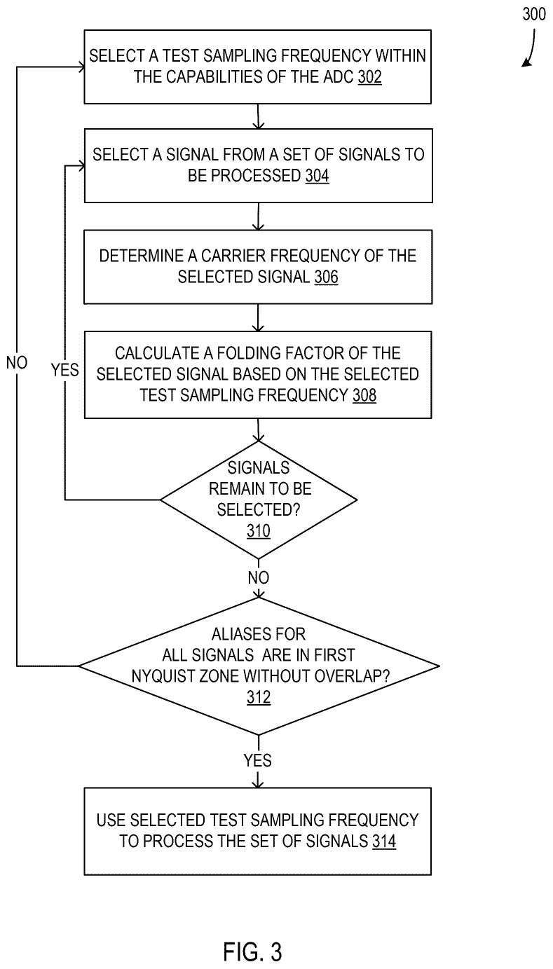

FIG. 3 is a flowchart illustrating a method 300 for determining a sampling frequency and associated folding factors of signals. In some examples, the method 300 is executed and/or otherwise performed as part of methods such as method 200 of FIG. 2 and/or in association with a system such as system 100 of FIG. 1.

At 302, a test sampling frequency within the capabilities of the ADC is selected.

At 304, a signal is selected from a set of signals to be processed. In some examples, the set of signals is the set of signals that are to be simultaneously monitored by the ADC as described herein.

At 306, the carrier frequency of the selected signal is determined and, at 308, a folding factor is calculated for the selected signal based on the selected test sampling frequency and the determined carrier frequency.

At 310, if signals remain to be selected from the set of signals, the process returns to 304 to select another signal. Alternatively, if no signals remain to be selected, the process proceeds to 312.

At 312, if the aliases for all signals are in the first Nyquist zone of the ADC without overlapping with each other, the process proceeds to 314. Alternatively, if the aliases for all signals are not all in the first Nyquist zone and/or two or more of the aliases overlap with each other, the process returns to 302 to select another test sampling frequency.

At 314, the selected test sampling frequency is used to process the set of signals. In some examples, processing the set of signals includes monitoring the signals simultaneously to detect GNSS interference and/or other types of signal behavior as described herein. In some examples, processing the set of signals includes causing a response action to be performed, for example as is described above with respect to the method 200 shown in FIG. 2.

In an example, for each GPS signal, particularly those from L1, L2, and L5 bands, the system assesses the carrier frequency and calculates a suitable (fₛ) to ensure that the folded frequency (f_{c}−nfₛ) remains within the range (−fₛ/2) to (fₛ /2). This calculation prevents inter-frequency interference by ensuring that each aliased signal is distinctly positioned in the Nyquist zone without overlap. The ultimate sample frequency determined accommodates simultaneous processing of these multiple signals, enabling more efficient use of the ADC's bandwidth while preserving signal fidelity.

In some examples, the process of determining the optimal sampling rate for undersampling GNSS signals involves several steps and mathematical considerations. The carrier frequencies of the GNSS signals to be processed are identified. For example, GPS signals typically include L1 (1575.42 MHz), L2 (1227.60 MHz), and L5 (1176.45 MHz) bands. a range of potential sampling frequencies that allow for undersampling are selected. The chosen frequencies are strategically lower than the Nyquist rate to foster aliasing into the desired Nyquist zone of the ADC for efficient processing. The integer folding factor (n) is computed for each signal, ensuring that the following condition is met: (|f_{c}−n fₛ|<fₛ /2). This ensures that the aliased GNSS signal fits within the ADC's first Nyquist zone that spans from (−fₛ/2) to (fₛ/2). Then, it is confirmed that the selected (fₛ) avoids overlap between aliased signals originating from different GNSS bands. The separation of aliased frequencies is computed for each potential (fₛ), ensuring non-overlapping mapping in the first Nyquist zone. The above calculations are iterated with different potential sampling frequencies to identify the optimal (fₛ) that simultaneously fits the requirements for all GNSS signals without inter-band interference.

Examples of determining folding factors for GNSS signals include a GPS L1 band example wherein the carrier frequency (f_{c}) is 1575.42 MHz and the initial sampling rate (fₛ) of 505 MHz is selected as a candidate. This example includes calculating n by solving for n such that |1575.42−n*505|<505/2, yielding n=3. In this example, the aliased frequency calculation is |1575.42−3*505|=60.42 MHz. The nyquist zone validation of this example fits into 0<60.42<252.50.

The examples of determining folding factors for GNSS signals include a GPS L2 band example wherein the carrier frequency (f_{c}) is 1227.60 MHz and the initial sampling rate (fₛ) of 505 MHz is selected as a candidate. This example includes calculating n by solving for n such that |1227.60−n*505|<505/2, yielding n=2. The aliased frequency calculation is |1227.60−2*505|=217.60 MHz. The nyquist zone validation of this example fits into 0<217.60<252.50.

The examples of determining folding factors for GNSS signals include a GPS L5 band example wherein the carrier frequency (f_{c}) is 1176.45 MHz and the initial sampling rate (fₛ) of 505 MHz is selected as a candidate. This example includes calculating n by solving for n such that |1176,45−n*505|<505/2, yielding n=2. The aliased frequency calculation is |1176.45-2*505|=166.45 MHz. The nyquist zone validation of this example fits into 0<166.45<252.50.

Through these calculations and iterations, an (e.g., optimal) undersampling rate is selected that effectively down-converts GNSS signals from multiple bands into a single Nyquist zone, promoting more efficient processing while avoiding cross-band interference.

Referring again to FIG. 1, the history data of collected GNSS signals (e.g., signal history data 138) may be utilized in several significant ways to enhance the performance and capabilities of GNSS signal processing systems. In some examples, the historical data provides a comprehensive record of past interference events, enabling the identification and classification of particular signals (e.g., jammer signals) over time. By analyzing patterns in this data, the system discerns recurring interference sources and predicts potential future disruptions, allowing for proactive mitigation measures. Further, the collected signal history aids in creating detailed “heat maps” of the RF environment. These maps visually represent areas of frequent interference and signal patterns, which can be used to optimize the positioning of antennas and/or adjust operational parameters in real-time to avoid problematic zones. Additionally, historical GPS signal data supports advanced DOA calculations by providing a reference dataset. This can improve real-time DOA estimations by leveraging past data to refine algorithm models, leading to more accurate identification of signal sources and interference origins.

The generation of a heat map using the history of captured GPS signals involves systematic analysis of the recorded signal data over a specified duration. This process is divided into the following example steps. GNSS signal data is captured and stored continuously over time, recording instances of received signals along with associated interference characteristics. This data is stored in a historical database (e.g., signal history data 138), which includes metadata such as signal strength, source direction, time of day, and interference patterns. The historical data is analyzed to identify repetitive patterns and variations in signal characteristics and interference levels. This includes evaluating the frequency, duration, and intensity of interference events across different geographic locations or signal reception environments. The analyzed data is correlated with geographical coordinates, utilizing location metadata to log where each interference event or signal variation has occurred. This results in a spatial representation of interference distributions over a defined area. The processed geographical and signal data are used to create a visual heat map representation. The heat map displays varying levels of signal interference or strength using color coding, where distinct colors indicate different intensity levels of signal reception and/or interference activities. In some examples, temporal aspects are overlaid onto the heat map, for example enabling users to observe how interference patterns change over time. This dynamic view can help identify trends or predict future interference events based on historical behavior.

The described heat map technology may be used in several example practical applications. For instance, in some examples, the heat map is used to identify regions with high levels of interference. This information helps in route planning or devising strategies to avoid these areas, thereby ensuring uninterrupted signal reception. Additionally, or alternatively, the placement and configuration of antennas or other signal reception hardware is optimized by analyzing regions needing improved coverage, ultimately enhancing overall performance and signal integrity. The calculation of direction-of-arrival for interfering signals can be aided using the heat map technology, for example using historical data to increase accuracy by refining algorithms based on observed patterns on the heat map. Further, in some examples, informed decision-making regarding deployment of GNSS-based systems, such as UAVs or communication devices, is enhanced by utilizing the heat map to understand interference baselines in different operational environments. Additionally, or alternatively, the heat map technology is used to support identification and classification of potential interference sources by comparing current signals with historical patterns, for example providing insights for mitigation, further investigative actions, and/or the like.

In some examples, the disclosed systems and methods are used to record and analyze the past history of signal characteristics (e.g., strength) with respect to geographic location. Patterns and/or changes of signal strength are observed over time, for example identifying areas where specific signals are weak or strong and/or detecting a change in signal strength that moves around geographically over time. Such detected patterns can then be used to take associated actions, such as, but not limited to, routing vehicles to avoid particular geographic areas with weak signal, investigating reasons a signal might be weak in a particular geographic location, and/or the like.

In some examples, historical data is used to train adaptive algorithms, including those based on machine learning, to better respond to changing environmental conditions. By learning from past signal behaviors, algorithms adjust more efficiently to maintain signal integrity and optimize processing performance. Further, historical signal data enables benchmarking of system performance over time, enabling operators to assess the effectiveness of jammer detection and mitigation strategies. Additionally, by cross-referencing historical GPS signal data with external events or environmental conditions, correlations are established that may inform future operational strategies and/or improvements in signal processing capabilities.

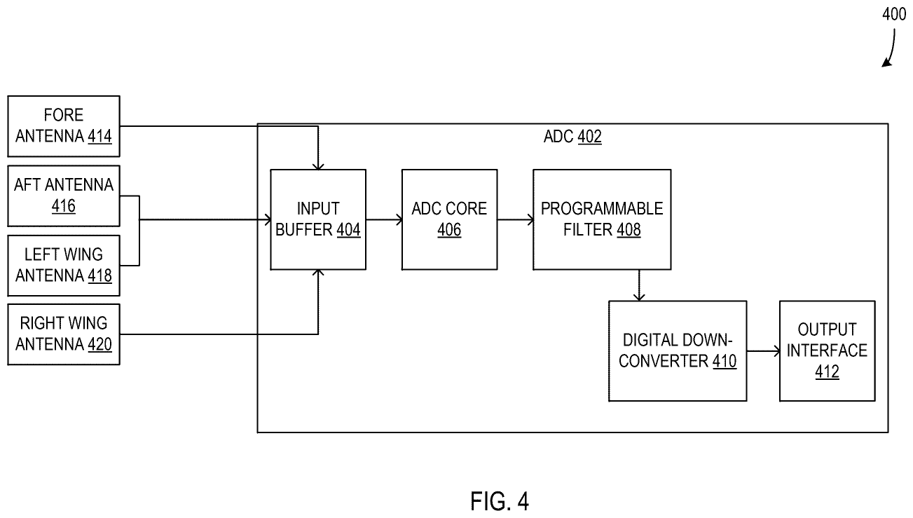

FIG. 4 is a functional block diagram 400 illustrating an example ADC 402 for use in the described systems and methods. The diagram exemplifies the integration of an ADC 402 that collects four channels of data. In some examples, the ADC 402 has multiple data channels. The ADC 402 includes an input buffer 404 connected to the ADC core 406. In some examples, the input buffer 404 is configured to prepare the analog signals for conversion by stabilization and/or isolation thereof. Further, in some examples, the ADC core 406 is configured to convert the analog signals into digital formats. In some examples, the resolution of the ADC core 406 is 14-bit or another resolution without departing from the scope of the description. Additionally, in some examples, the ADC core 406 is equipped with fast detection and signal monitor components, facilitating more rapid signal acquisition and/or analysis.

Data from the ADC core 406 is provided to the programmable filter 408. In some examples, the programmable filter 408 is configured to condition the signal to reduce unwanted noise or to otherwise filter the digital signals. The programmable filter 408 provides output data to the digital downconverter 410, which is configured to reduce the sampling rate or bandwidth of the signal for further processing and/or compatibility with output requirements. Finally, the digital data is output using the output interface 412. In some examples, the output interface 412 is configured to output the data using serialization and/or other data output methods.

Possible antenna placements on a UAV are denoted as fore antenna 414, aft antenna 416, left wing antenna 418, and right wing antenna 420, for example enabling more effective multi-directional signal reception and processing.

Further, in some examples, signal processing techniques are used to enhance the capabilities of the described systems and methods, such as, but not limited to, decimation, low pass filtering, bandpass filtering, and/or the like.

In other examples, other types of ADCs with other component organizations are used to perform other data processing techniques in the described systems and methods without departing from the scope of the description.

In an example, aspects of the disclosure include antenna filtering to reduce the potential for other unrelated signals from aliasing down to the first Nyquist zone for the chosen sampling rate, which can happen if the full RF bandwidth (6 GHz in this example) is equally capable of being down-converted. In some such cases, a system without filtering could unintentionally down-convert Wi-Fi and/or cellular phone traffic if not careful on filtering selections. This filtering can be arranged strategically by using both RF filtering (at the antennas) and/or at the down-converted first Nyquist zone (by placing offending signals in the stopband of the lowpass or bandpass baseband filters before any further signal processing).

Further, in some examples, aspects of the disclosure include using a suitable margin of unused bandwidth to later filter and separate the signals in DSP should it be necessary. For example, the selected undersampling rate cannot be arbitrarily chosen otherwise co-interference will occur (frequencies alias to the same first Nyquist zone frequencies and cannot be separated).

Additionally, or alternatively, aspects of the disclosure enable simultaneous viewing of multiple GNSS signals to: identify one or more discrete emitters (jammers); not be fooled if one band ‘disappears’ as the enemy may sense our approach and turn off one specific emitter or band of frequencies; and/or help in classifying the threat by cataloging aspects of all three (or more) bands and how they may be related.

Further, aspects of the disclosure enable determining which GNSS band signals may be related, that is, generated from the same emitter. For example, the systems and methods disclosed herein may be configured to track doppler shifts and/or environmental aspects such as fading, ground reflections, and/or the like.

FIG. 5 illustrates an exemplary implementation of the GNSS signal monitoring platform 116 being deployed onboard a mobile platform 500. The system 100 is configured to perform the operations disclosed herein from onboard the mobile platform 500. For example, the system 100 may simultaneously monitor multiple GNSS signals, analyze the monitored signals for interference and/or other notable patterns, and cause actions to be performed in response to the detected behaviors, for example as the mobile platform 500 moves along a path (e.g., a flight path, a ground path, a marine path, etc.) and/or while the mobile platform 500 is stationary.

Although shown as a UAV rotorcraft, the mobile platform 500 is not limited thereto but rather may include any other type of mobile platform.

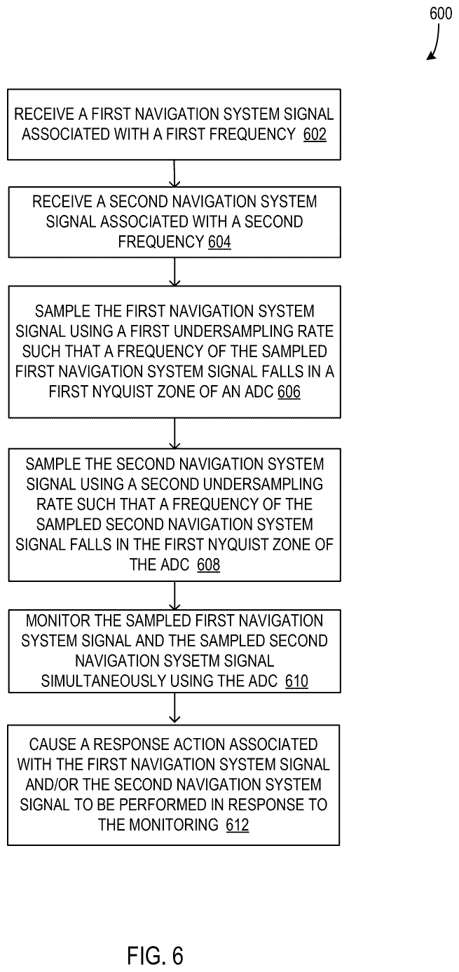

FIG. 6 is a flowchart illustrating an example of a method 600 of operations, functions, and/or the like of the system 100 (FIG. 1). At 602, the method 600 includes receiving a first navigation system signal associated with a first frequency. At 604, the method 600 includes receiving a second navigation system signal associated with a second frequency. At 606, the method 600 includes sampling the first navigation system signal using a first undersampling rate such that a frequency of the sampled first navigation system signal falls in a first Nyquist zone of an analog to digital converter (ADC). The method 600 includes, at 608, sampling the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously. At 610, the method 600 includes monitoring the sampled first navigation system signal and the sampled second navigation system signal simultaneously using the ADC. At 612, the method 600 includes causing a response action associated with at least one of the first navigation system signal or the second navigation system signal to be performed in response to the monitoring.

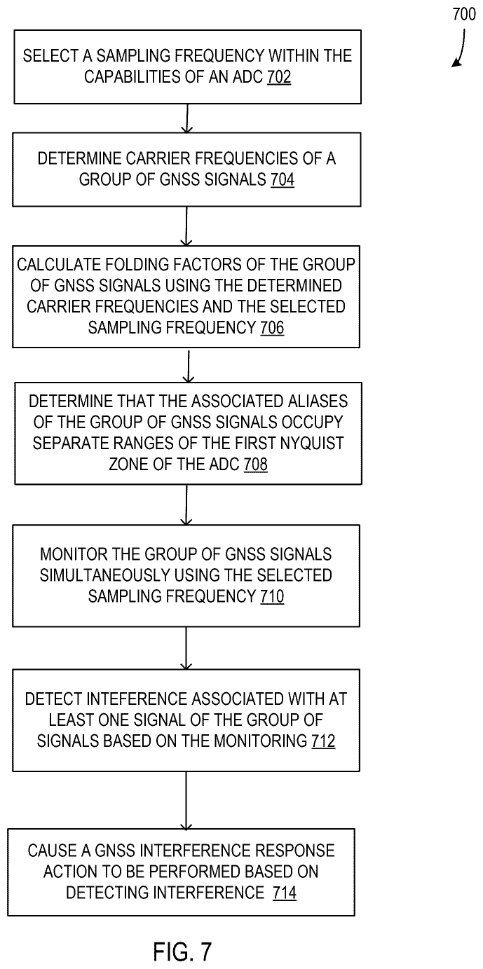

FIG. 7 is a flowchart illustrating an example of a method 700 of operations, functions, and/or the like of the system 100 (FIG. 1). At 702, the method 700 includes selecting a sampling frequency within capabilities of an analog to digital converter (ADC). At 704, the method 700 includes determining carrier frequencies of a group of global navigation satellite system (GNSS) signals. The method 700 includes, at 706, calculating folding factors of the group of GNSS signals using the determined carrier frequencies and the selected sampling frequency, wherein the calculated folding factors cause associated aliases of the group of GNSS signals to fall within a first Nyquist zone of the ADC. At 708, the method 700 includes determining that the associated aliases of the group of GNSS signals occupy separate ranges of the first Nyquist zone of the ADC. The method 700 includes, at 710, monitoring the group of GNSS signals simultaneously using the selected sampling frequency. At 712, the method 700 includes detecting interference associated with at least one signal of the group of signals based on the monitoring. At 714, the method 700 includes causing a GNSS interference response action to be performed based on detecting interference.

### Exemplary Operating Environment

The present disclosure is operable with a computing apparatus according to an embodiment as a functional block diagram 800 in FIG. 8. In an example, components of a computing apparatus 818 are implemented as a part of an electronic device according to one or more implementations described in this specification. The computing apparatus 818 comprises one or more processors 819 which may be microprocessors, controllers, or any other suitable type of processors for processing computer executable instructions to control the operation of the electronic device. Alternatively, or in addition, the processor 819 is any technology capable of executing logic or instructions, such as a hard-coded machine. In some examples, platform software comprising an operating system 820 and/or any other suitable platform software is provided on the apparatus 818 to enable application software 821 to be executed on the device. In some examples, undersampling multiple GNSS signals to a first Nyquist zone of an ADC and simultaneously monitoring the multiple sampled signals as described herein is accomplished by software, hardware, and/or firmware.

In some examples, computer executable instructions are provided using any computer-readable media that is accessible by the computing apparatus 818. Computer-readable media include, for example, computer storage media and communications media. Computer storage media, such as a memory 822, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 822) is shown within the computing apparatus 818, it will be appreciated by a person skilled in the art, that, in some examples, the storage is distributed or located remotely and accessed via a network or other communication link (e.g., using a communication interface 823).

Further, in some examples, the computing apparatus 818 comprises an input/output controller 824 configured to output information to one or more output devices 825, for example a display (e.g., displaying a GUI) or a speaker, which are separate from or integral to the electronic device. Additionally, or alternatively, the input/output controller 824 is configured to receive and process an input from one or more input devices 826, for example, a keyboard, a microphone, or a touchpad. In one example, the output device 825 also acts as the input device. An example of such a device is a touch sensitive display. The input/output controller 824 may also output data to devices other than the output device, e.g., a locally connected printing device. In some examples, a user provides input to the input device(s) 826 and/or receives output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, and/or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Aspects of the disclosure include a system that includes a processor, and a memory including computer program code. The memory and the computer program code are configured to cause the processor to: receive a first navigation system signal associated with a first frequency; receive a second navigation system signal associated with a second frequency; sample the first navigation system signal using a first undersampling rate such that a frequency of the sampled first navigation system signal falls in a first Nyquist zone of an analog to digital converter (ADC); sample the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously; monitor the sampled first navigation system signal and the sampled second navigation system signal simultaneously using the ADC; and cause a response action associated with at least one of the first navigation system signal and the second navigation system signal to be performed in response to the monitoring.

In some examples, the first undersampling rate and the second undersampling rate are the same rate.

Aspects of the disclosure include a computerized method that includes: select a sampling frequency within capabilities of an analog to digital converter (ADC); determine carrier frequencies of a group of GNSS signals; calculate folding factors of the group of GNSS signals using the determined carrier frequencies and the selected sampling frequency, wherein the calculated folding factors cause associated aliases of the group of GNSS signals to fall within a first Nyquist zone of the ADC; determine that the associated aliases of the group of GNSS signals occupy separate ranges of the first Nyquist zone of the ADC; monitor the group of GNSS signals simultaneously using the selected sampling frequency; detect interference associated with at least one signal of the group of signals based on the monitoring; and cause a GNSS interference response action to be performed based on detecting interference.

Aspects of the disclosure include a method for enhanced Global Navigation Satellite System (GNSS) signal processing and jammer detection, including: receiving GNSS signals across multiple frequency bands using a receiver apparatus, the receiver apparatus including a multi-antenna configuration capable of capturing signals from a plurality of GNSS constellations; converting the received GNSS signals from analog to digital format using an analog-to-digital converter (ADC); undersampling the GNSS signals, wherein the undersampling process includes determining an optimal sampling rate such that aliased frequency signals corresponding to multiple GNSS bands are positioned within a first Nyquist zone of the ADC, thereby enabling simultaneous multi-band processing; performing signal jammer detection by identifying and discriminating jammer signals in both narrowband and wideband digital down-conversion modes, wherein the detection process involves tracking, classifying, and prioritizing interference sources; utilizing a historical database of signal receptions to create a radio landscape map, the map facilitating direction-of-arrival calculations and enhancing the detection and processing of jammer signals; dynamically controlling the digital receiver circuit parameters, including capture bandwidth, sampling rate, filtering, and decimation, in response to varying threat levels and operational requirements, thereby optimizing signal acquisition efficiency; conducting calibration procedures both offline and during real-time operation, wherein calibration involves the adjustment of transmit antennas on a host platform to maintain consistent signal integrity and adaptive phasing; and applying signal processing algorithms to refine the processing of the received GNSS signals and adaptively filter data in response to environmental changes and interference conditions.

Aspects of the disclosure include a method for processing GNSS signals and detecting signal jammers that includes: receiving GNSS signals from multiple constellations across various frequency bands using a multi-antenna receiver apparatus; converting the received signals to digital format with an ADC capable of 6 GHz wideband processing and a sample rate of 600 mega samples per second; undersampling the signals to position aliased frequencies within the ADC's first Nyquist zone for simultaneous multi-band processing; detecting signal jammers by distinguishing jammer signals in narrowband and wideband modes, utilizing a historical database for interference source tracking and direction-of-arrival calculations; dynamically adjusting receiver parameters including bandwidth, sampling rate, and filtering in response to threat levels; and conducting both offline and real-time calibration using transmit antennas to maintain signal integrity, applying advanced processing algorithms such as Multiple Signal Classification (MUSIC) and AI to refine signal processing in changing environments.

Aspects of the disclosure include a system for enhanced navigation signal processing and interference detection in a UAV that includes: an array of antennas mounted on the UAV, configured for receiving GNSS signals across a plurality of frequency bands from multiple GNSS constellations; an ADC operatively coupled to the array of antennas, the ADC being capable of wideband processing up to 6 GHz and having a sampling rate of up to 600 mega samples per second, for converting received analog signals to digital format; a signal processing module, configured to perform undersampling on the digitally converted GNSS signals, wherein undersampling involves selecting a sampling rate that positions aliased frequencies within a first Nyquist zone of the ADC, thereby allowing simultaneous processing of signals from multiple GNSS frequency bands; a jammer detection module, configured to identify and differentiate GPS jammer signals in both narrowband and wideband digital down-conversion modes, and to utilize a database of signal receptions for historical interference analysis and direction-of-arrival calculations; a dynamic control unit, actively adjusting digital receiver parameters, including capture bandwidth, sampling rate, signal filtering, and decimation, in response to detected threat levels and operational requirements, optimizing the UAV's signal acquisition and processing in real-time; a calibration system, performing calibration procedures both before flight and during real-time operation, wherein calibration adjusts the phase parameters of the antennas to maintain signal integrity, compensating for environmental factors such as temperature changes or ADC restarts; and a processing algorithm suite, employing advanced algorithms including Multiple Signal Classification (MUSIC) and optionally integrating artificial intelligence to enhance GNSS signal processing, adaptively filtering signal data to optimize performance in varying environmental and interference conditions.

Aspects of the disclosure include a system that includes a processor and a memory including computer program code. The memory and the computer program code are configured to cause the processor to: receive a first navigation system signal associated with a first frequency; receive a second navigation system signal associated with a second frequency; sample the first navigation system signal using a first undersampling rate such that a frequency of the sampled first navigation system signal falls in a first Nyquist zone of an analog to digital converter (ADC); sample the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously; monitor the sampled first navigation system signal and the sampled second navigation system signal simultaneously using the ADC; and cause a response action associated with at least one of the first navigation system signal or the second navigation system signal to be performed in response to the monitoring.

In some examples, the first undersampling rate and the second undersampling rate are the same rate.

In some examples, the memory and the computer program code are configured to cause the processor to detect interference based on the monitoring.

In some examples, causing the response action to be performed in response to the monitoring includes causing the response action to be performed based on detected interference.

In some examples, the memory and the computer program code are configured to cause the processor to at least one of record or analyze data associated with the monitoring to determine a type of the response action.

In some examples, causing the response action to be performed in response to the monitoring includes causing a device to change at least one of a channel or a constellation.

In some examples, causing the response action to be performed in response to the monitoring includes causing a vehicle to change a route of the vehicle.

In some examples, causing the response action to be performed in response to the monitoring includes at least one of providing or displaying a heat map.

In some examples, the ADC is configured to process signals up to approximately 6 GHZ with a sample rate of up to approximately 600 mega samples per second.

Aspects of the disclosure includes a computerized method that includes: selecting a sampling frequency within capabilities of an analog to digital converter (ADC); determining carrier frequencies of a group of global navigation satellite system (GNSS) signals; calculating folding factors of the group of GNSS signals using the determined carrier frequencies and the selected sampling frequency, wherein the calculated folding factors cause associated aliases of the group of GNSS signals to fall within a first Nyquist zone of the ADC; determining that the associated aliases of the group of GNSS signals occupy separate ranges of the first Nyquist zone of the ADC; monitoring the group of GNSS signals simultaneously using the selected sampling frequency; detecting interference associated with at least one signal of the group of signals based on the monitoring; and causing a GNSS interference response action to be performed based on detecting interference.

In some examples, causing the GNSS interference response action to be performed includes causing a device to change at least one of a channel or a constellation.

In some examples, causing the GNSS interference response action to be performed includes causing a vehicle to change a route of the vehicle.

In some examples, causing the GNSS interference response action to be performed includes at least one of providing or displaying a heat map.

In some examples, the ADC is configured to process signals up to approximately 6 GHZ with a sample rate of up to approximately 600 mega samples per second.

Aspects of the disclosure include a computerized method that includes: receiving a first navigation system signal associated with a first frequency; receiving a second navigation system signal associated with a second frequency; sampling the first navigation system signal using a first undersampling rate such that a frequency of the sampled first navigation system signal falls in a first Nyquist zone of an analog to digital converter (ADC); sampling the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously; monitoring the sampled first navigation system signal and the sampled second navigation system signal simultaneously using the ADC; detect interference based on the monitoring; and causing a response action associated with at least one of the first navigation system signal or the second navigation system signal to be performed in response to the detected interference.

In some examples, the first undersampling rate and the second undersampling rate are the same rate.

In some examples, the method further includes at least one of recording or analyzing data associated with the monitoring to determine a type of the response action.

In some examples, causing the response action to be performed in response to the detected interference includes causing a device to change at least one of a channel or a constellation.

In some examples, causing the response action to be performed in response to the detected interference includes causing a vehicle to change a route of the vehicle.

In some examples, causing the response action to be performed in response to the detected interference includes at least one of providing or displaying a heat map.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or ”exactly one of,“ or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as ”either,“ ”one of′ “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a processor; and
a memory comprising computer program code, the memory and the computer program code configured to cause the processor to:
receive a first navigation system signal associated with a first frequency;
receive a second navigation system signal associated with a second frequency;
sample the first navigation system signal using a first undersampling rate such that a frequency of the sampled first navigation system signal falls in a first Nyquist zone of an analog to digital converter (ADC);
sample the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously;
monitor the sampled first navigation system signal and the sampled second navigation system signal simultaneously using the ADC; and
cause a response action associated with at least one of the first navigation system signal or the second navigation system signal to be performed in response to the monitoring.

2. The system of claim 1, wherein the first undersampling rate and the second undersampling rate are the same rate.

3. The system of claim 1, wherein the memory and the computer program code are configured to cause the processor to detect interference based on the monitoring.

4. The system of claim 1, wherein causing the response action to be performed in response to the monitoring comprises causing the response action to be performed based on detected interference.

5. The system of claim 1, wherein the memory and the computer program code are configured to cause the processor to at least one of record or analyze data associated with the monitoring to determine a type of the response action.

6. The system of claim 1, wherein causing the response action to be performed in response to the monitoring comprises causing a device to change at least one of a channel or a constellation.

7. The system of claim 1, wherein causing the response action to be performed in response to the monitoring comprises causing a vehicle to change a route of the vehicle.

8. The system of claim 1, wherein causing the response action to be performed in response to the monitoring comprises at least one of providing or displaying a heat map.

9. The system of claim 1, wherein the ADC is configured to process signals up to approximately 6 GHZ with a sample rate of up to approximately 600 mega samples per second.

10. A computerized method comprising:
selecting a sampling frequency within capabilities of an analog to digital converter (ADC);
determining carrier frequencies of a group of global navigation satellite system (GNSS) signals;
calculating folding factors of the group of GNSS signals using the determined carrier frequencies and the selected sampling frequency, wherein the calculated folding factors cause associated aliases of the group of GNSS signals to fall within a first Nyquist zone of the ADC;
determining that the associated aliases of the group of GNSS signals occupy separate ranges of the first Nyquist zone of the ADC;
monitoring the group of GNSS signals simultaneously using the selected sampling frequency;
detecting interference associated with at least one signal of the group of signals based on the monitoring; and
causing a GNSS interference response action to be performed based on detecting interference.

11. The computerized method of claim 10, wherein causing the GNSS interference response action to be performed comprises causing a device to change at least one of a channel or a constellation.

12. The computerized method of claim 10, wherein causing the GNSS interference response action to be performed comprises causing a vehicle to change a route of the vehicle.

13. The computerized method of claim 10, wherein causing the GNSS interference response action to be performed comprises at least one of providing or displaying a heat map.

14. The computerized method of claim 10, wherein the ADC is configured to process signals up to approximately 6 GHZ with a sample rate of up to approximately 600 mega samples per second.

15. A computerized method comprising:
receiving a first navigation system signal associated with a first frequency;
receiving a second navigation system signal associated with a second frequency;
sampling the first navigation system signal using a first undersampling rate such that a frequency of the sampled first navigation system signal falls in a first Nyquist zone of an analog to digital converter (ADC);
sampling the second navigation system signal using a second undersampling rate such that a frequency of the sampled second navigation system signal falls in the first Nyquist zone of the ADC, wherein the sampling of the first navigation system signal and the sampling of the second navigation system signal are performed simultaneously;
monitoring the sampled first navigation system signal and the sampled second navigation system signal simultaneously using the ADC;
detect interference based on the monitoring; and
causing a response action associated with at least one of the first navigation system signal or the second navigation system signal to be performed in response to the detected interference.

16. The computerized method of claim 15, wherein the first undersampling rate and the second undersampling rate are the same rate.

17. The computerized method of claim 15, further comprising at least one of recording or analyzing data associated with the monitoring to determine a type of the response action.

18. The computerized method of claim 15, wherein causing the response action to be performed in response to the detected interference comprises causing a device to change at least one of a channel or a constellation.

19. The computerized method of claim 15, wherein causing the response action to be performed in response to the detected interference comprises causing a vehicle to change a route of the vehicle.

20. The computerized method of claim 15, wherein causing the response action to be performed in response to the detected interference comprises at least one of providing or displaying a heat map.
